(19) United States
(12) Patent Application Publication
(10) Pub. No.: US 2015/0076027 A1
(43) Pub. Date: Mar. 19, 2015

(54) STRUCTURAL SUPPORT MEMBERS FOR PACKING, SHIPPING, AND/OR STORING DECORATIVE CONTAINERS, APPARATUS CONTAINING SAME, AND METHODS OF PRODUCTION AND USE THEREOF

(71) Applicant: Wanda Weder & William Straeter, not individually but solely as Trustees of The Family Trust U/T/A, Highland, IL (US)

(72) Inventor: Donald E. Weder, Highland, IL (US)

(21) Appl. No.: 14/475,197

(22) Filed: Sep. 2, 2014

Related U.S. Application Data
(60) Provisional application No. 61/872,104, filed on Aug. 30, 2013.

(51) Int. Cl. B65D 21/02; B65G 57/00; B65B 11/02

(52) U.S. Cl. CPC B65D 21/0233; B65B 11/02; B65G 57/00
USPC 206/499; 53/397; 53/441; 414/802

(57) ABSTRACT

Devices and apparatuses for packing, shipping, and/or storing containers, as well as methods of producing and using same, are disclosed.

### CROSS REFERENCE TO RELATED APPLICATIONS/INCORPORATION BY REFERENCE STATEMENT

This application claims benefit under 35 USC §119(e) of provisional application U.S. Ser. No. 61/872,104, filed Aug. 30, 2013. The entire contents of the above-referenced patent application are hereby expressly incorporated herein by reference.

### STATEMENT REGARDING FEDERALLY SPONSORED RESEARCH AND DEVELOPMENT

Not Applicable.

### BACKGROUND

Decorative floral containers have been used for many years to accentuate or complement the aesthetic appearance of a floral grouping and/or a potted plant. Such decorative covers are often preformed flower pot covers made by forming a flexible sheet of material into a shape adapted to receive a flower pot. In the process of forming the sheet of material into the flower pot cover, a plurality of overlapping folds is formed in the sheet of material. The overlapping folds cooperate to provide structural strength to keep the preformed shape of the flower pot cover. In addition, flower pot covers are often formed to have a skirt portion which is designed to extend beyond the upper end of the flower pot and functions to cover the soil and the lower portion or stem portion of a floral grouping which can be unattractive, and thus draw away from the attractiveness of the combination of the blooms of the floral grouping and the flower pot cover.

To transport flower pot covers after the forming process, a plurality of preformed flower pot covers are typically stacked or nested relative to one another, and the stack is placed in a cardboard box. After several stacks of the preformed flower pot covers have been placed in the box, the box is closed and sealed. While the use of cardboard boxes has been widely accepted in the packaging and transporting of preformed flower pot covers, they are not without disadvantages. For example, cardboard boxes represent a disposal problem for the receiver of the flower pot covers. In addition, the contents of the box cannot be inspected without unsealing and opening the box. As such, one is unable to observe the quality and quantity of the flower pot covers prior to opening the box.

Improved methods of shipping preformed flower pot covers are described in U.S. Pat. No. 6,122,896, issued Sep. 26, 2000 to Weder et al.; U.S. Pat. No. 6,405,871, issued Jun. 18, 2002 to Craig et al.; U.S. Pat. No. 6,725,627, issued Apr. 27, 2004 to Weder et al.; and U.S. Pat. No. 7,836,665, issued Nov. 23, 2010 to Weder (the entire contents of the above-referenced patents being hereby expressly incorporated herein by reference).

A wide variety of floral containers are currently on the market. However, generally only a single size and shape of floral container is shipped together currently. Thus, a large quantity of a single size/shape floral container must be present in a single shipment. In addition, the space present in a single shipment of floral containers is not optimized in the current shipping methods.

Therefore, there is a need in the art for improved apparatuses and methods of packaging containers that maximize shipping space and provide increased stability to the containers during packing, shipping, and/or storage thereof. The presently disclosed and/or claimed inventive concept(s) is directed to such apparatuses and methods that overcome the disadvantages and defects of the prior art.

### BRIEF DESCRIPTION OF THE DRAWINGS

FIG. 1 is a perspective view of a substantially flat sheet of material from which one embodiment of a structural support member constructed in accordance with the presently disclosed and/or claimed inventive concept(s) is formed.

FIGS. 2A-B illustrate a structural support member formed from the substantially flat sheet of material of FIG. 1, wherein the structural support member is in the erect condition. FIG. 2A is a perspective view of the structural support member, while FIG. 2B contains a cutaway top view of the structural support member, illustrating the overlap between two segments of the sheet of material of FIG. 1.

FIG. 3 is a perspective view of another substantially flat sheet of material from which another embodiment of a structural support member constructed in accordance with the presently disclosed and/or claimed inventive concept(s) is formed.

FIG. 4 is a perspective view of the structural support member formed from the substantially flat sheet of material of FIG. 3.

FIGS. 5-7 are various perspective views of one embodiment of an apparatus constructed in accordance with the presently disclosed and/or claimed inventive concept(s), wherein the apparatus contains a plurality of different structural support members.

FIG. 8 is a perspective view of a packaged unit formed from the apparatus of FIGS. 5-7 and four stacks of preformed flower pot covers. Each of the four stacks of preformed flower pot covers is disposed in an inverted orientation on one of the structural support members of the apparatus.

FIG. 9 is a perspective view of a packaged unit formed from the apparatus of FIGS. 5-7 and five stacks of preformed flower pot covers. Four of the stacks of preformed flower pot covers are disposed in an inverted orientation, each on a structural support member of the apparatus. The fifth stack of preformed flower pot covers is disposed on the apparatus in an upright orientation and is supported in between the four inverted stacks of preformed flower pot covers.

FIG. 10 is a top plan view of the packaged unit of FIG. 9.

FIG. 11 is a perspective view of another embodiment of an apparatus constructed in accordance with the presently disclosed and/or claimed inventive concept(s). The apparatus is similar to that shown in FIGS. 5-7, except that the apparatus includes a plurality of structural support members disposed in at least two different orientations on a platform.

FIG. 12 is a perspective view of a packaged unit formed from the apparatus of FIG. 11 and five stacks of preformed flower pot covers. Four of the stacks of preformed flower pot covers are supported in an inverted orientation, each on one of the structural support members disposed on the platform. The fifth stack of preformed flower pot covers is supported in an upright orientation, wherein at least a portion of a terminal cover in the fifth stack is disposed within at least a portion of the fifth structural support member.

FIGS. 13-14 are perspective views of another embodiment of an apparatus constructed in accordance with the presently disclosed and/or claimed inventive concept(s), wherein the apparatus contains a platform, a plurality of structural support members, and a stacking element.

FIG. 15 is a perspective view of one embodiment of a stacking element constructed in accordance with the presently disclosed and/or claimed inventive concept(s).

FIG. 16A is a photograph of a packaged unit constructed in accordance with the presently disclosed and/or claimed inventive concept(s).

FIGS. 16B and 16C are photographs of two comparisons of the space occupied by a certain number of preformed flower pot covers packaged either in accordance with the presently disclosed and/or claimed inventive concept(s) (left side of each photo) or by the prior art traditional carton method (right side of each photo).

FIG. 17 contains top plan (left) and perspective (right) views of a truck load plan for shipment of stacks of preformed flower pot covers using the apparatuses of the presently disclosed and/or claimed inventive concept(s).

FIGS. 18A and 18B each contain a top plan (left) and a perspective (right) view of a truck load plan for two trucks that are required for shipment of the same number of preformed flower pot covers as in FIG. 17 but packaged in the prior art floor loaded cartons.

### DETAILED DESCRIPTION

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed and/or claimed herein can be made and executed without undue experimentation in light of the present disclosure. While the articles and methods of the presently disclosed and/or claimed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed and/or claimed inventive concept(s). All such similar substitutes and modifications apparent to those skilled in the art are deemed to be within the spirit, scope, and concept of the presently disclosed and/or claimed inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

The term “container” as used herein will be understood to include any container used to contain and/or support object(s) at an end use, and wherein a plurality of containers (in an open condition) are stacked and/or nested for packaging, shipment, and/or storage thereof. The containers may have any size and shape and assume any configuration, so long as the containers may be disposed in a stack of containers for packaging, shipment, and/or storage thereof. One non-limiting example of a container that may be utilized in accordance with the presently disclosed and/or claimed inventive concept(s) is a floral container.

The term “floral container” as used herein will be understood to include any preformed container that is used to contain and/or support floral object(s) and that is packed, shipped, and/or stored in an open condition. In certain embodiments, the preformed container may be substantially flexible such that increased stability thereof is desired when packing, shipping, and/or storing stacked (and/or nested) quantities of the containers. The floral container may be sized and shaped for use with any floral object(s) known in the art, including but not limited to, floral groupings, flower pots, potted plants, botanical items, growing and/or retaining medium, propagules, and the like. Non-limiting examples of floral containers include preformed flower pot covers, containers for floral groupings, flower pots, overpots, combinations thereof, and the like.

Preformed flower pot covers are well-known in the art. Non-limiting examples of preformed flower pot covers that may be utilized in accordance with the presently disclosed and/or claimed inventive concept(s) are disclosed in U.S. Pat. No. 4,773,182, issued to Weder et al. on Sep. 27, 1998; and U.S. Pat. No. 5,291,721, issued to Weder et al. on Mar. 8, 1994 (each of these patents being expressly incorporated herein by reference in its entirety). However, any preformed flower pot covers known in the art or otherwise capable of use in the devices/apparatuses/methods of the presently disclosed and/or claimed inventive concept(s) also fall within the scope thereof.

The term “floral grouping” as used herein will be understood to include cut fresh flowers, artificial flowers, a single flower, or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item, or a propagule. The term “floral grouping” may be used interchangeably herein with the term “floral arrangement.”

The term “growing medium” when used herein will be understood to include any liquid, solid or gaseous material used for plant growth or for the cultivation of propagules, including organic and inorganic materials such as, but not limited to, soil, humus, perlite, vermiculite, sand, water, and including the nutrients, fertilizers, hormones, or combinations thereof required by the plants or propagules for growth.

The term “botanical item” when used herein will be understood to include a natural or artificial herbaceous or woody plant, taken singularly or in combination. The term “botanical item” also includes any portion or portions of natural or artificial herbaceous or woody plants including stems, leaves, flowers, blossoms, buds, blooms, cones, or roots, taken singly or in combination, or in groupings of such portions such as, but not limited to, bouquets or floral groupings.

The term “propagule” when used herein will be understood to include any structure capable of being propagated or acting as an agent of reproduction including seeds, shoots, stems, runners, tubers, plants, leaves, roots or spores.

The term “associate” as used herein will be understood to refer to the direct or indirect connection of two or more items. The two or more items may be directly attached to one another by any mechanism known in the art or otherwise contemplated herein; optionally, the two or more items may be unattached but remain in contact or close proximity to one another.

The term “securing element” as used herein will be understood to include, but not be limited to, adhesives and/or cohesives, stretch films, shrink wraps, straps, tapes (including single or double-sided adhesive tapes), elastic and/or non-elastic bands, elastic and/or non-elastic strings, twine, ribbons, elastic and/or non-elastic pieces of material, a round piece of material, a flat piece of material, a piece of paper strip, a piece of plastic strip, a piece of wire, ties, magnetic materials, mechanical and/or barb-type fastening materials and/or clamps, as well as any combination thereof.

The term “condition modifying element” as used herein will be understood to refer to any element that is capable of facilitating erecting and/or collapsing of a structural support member of the presently disclosed and/or claimed inventive concept(s). Examples of condition modifying elements that may be utilized in accordance with the presently disclosed and/or claimed inventive concept(s) include, but are not limited to, score lines, hinges, concentric sections, interlocking concentric sections, pivotally interlocking sections, sections of material which are thinner than the remainder of the structural support member, sections of material which are more flexible than the remainder of the structural support member, pleats, folds, perforations, creases, voids, partially or wholly cut through areas, removed portions of material, a V-shaped or U-shaped member, excess material, flexible material, stretchable material, and combinations thereof.

Turning now to the presently disclosed and/or claimed inventive concept(s), devices, apparatuses, and methods for the packing, shipping, and/or storing of containers (such as, but not limited to, floral containers) are provided. The devices/apparatuses may function to maximize shipping space and/or provide increased stability to the containers during packing, shipping, and/or storage thereof. While certain embodiments of the presently disclosed and/or claimed inventive concept(s) are disclosed in detail herein below, it is to be understood that the scope of the presently disclosed and/or claimed inventive concept(s) is not to be construed as limited to the particular disclosure provided. Rather, the scope of the presently disclosed and/or claimed inventive concept(s) extends to other embodiments that are within the skill of a person of ordinary skill in the art to develop without undue experimentation, given the disclosure of the subject application.

In certain embodiments, the presently disclosed and/or claimed inventive concept(s) includes an erectable and/or collapsible structural support member for use in the packing, shipping, and/or storing of a stack of containers (such as, but not limited to, a stack of nested floral containers). The structural support member has a flattened condition and an erect condition, as well as a top, a bottom, a sidewall, and an outer peripheral surface. The structural support member is shaped to stabilize, receive, and/or protect at least a portion of at least one container that is to be packed, shipped, and/or stored within an apparatus that includes the structural support member.

In certain embodiments, the structural support member may further have an inner peripheral surface. In this embodiment, when the structural support member is in the erect condition, the inner peripheral surface thereof defines a receiving space of the structural support member.

The structural support members may support a stack of containers by any method known in the art or otherwise contemplated herein. For example, but not by way of limitation, the structural support member may be sized, shaped, and designed so that the outer peripheral surface thereof is capable of contacting at least a portion of a peripheral surface of a terminal container in a stack of containers. If the peripheral surface of the terminal container is an inner peripheral surface thereof, the containers are supported in an inverted orientation, wherein an opening in the containers extends in a downward direction. Alternatively, multiple structural support members may each contact a portion of an outer peripheral surface of a terminal container and support the container therebetween in an upright orientation.

In another non-limiting example, the structural support member may be sized, shaped, and designed so that the receiving space present in the erect condition thereof is capable of receiving at least a portion of the terminal container (such as, but not limited to, a base portion thereof) in a stack of containers; in this manner, the containers are supported in an upright orientation, wherein an opening in the containers extends in an upward direction. In a particular example, the structural support member may be sized and shaped so that the inner peripheral surface thereof contacts at least a portion of an outer peripheral surface of a portion of the terminal container in a stack of containers. In addition, the receiving space and/or other portions of the structural support member may further be sized, shaped, and designed to surround and/or otherwise accommodate a specific portion of the terminal container in a stack of containers. For example, but not by way of limitation, the structural support member may be utilized with a stack of floral containers, wherein each of the containers has a base portion and a skirt portion; an upper portion of the sidewall of the structural support member may have an outwardly extending angular surface so that when at least a portion of the terminal container of the stack of containers is placed in the receiving space of the structural support member, a portion of the skirt portion of the terminal container is positioned on and supported by the angular surface disposed about the upper portion of the receiving space of the structural support member, thereby supporting and/or protecting the skirt portions of the remaining containers in the stack.

The structural support member may be formed of any material that is capable of allowing the structural support member to function in accordance with the presently disclosed and/or claimed inventive concept(s), i.e., be collapsed and erected, be associated with a platform, and support containers during packaging, shipment, and/or storage thereof. Non-limiting examples of materials from which the structural support members may be formed include cardboard (including but not limited to, a single face corrugated stock), natural polymers, synthetic polymers, plastic, paper, cloth, a rubber material, metallized film, foil, metal, and clay, as well as any combination, aggregation, and/or lamination thereof.

In one embodiment, the structural support member is formed of cardboard. In particular, the structural support member may be formed of a single face corrugated stock (a corrugated material laminated to one flat sheet rather than the laminated between two flat sheets in other embodiments of cardboard). The corrugated/fluted side of the single face corrugated stock may be disposed on the inner peripheral surface or the outer peripheral surface of the erected structural support member. When the corrugated/fluted side of the single face corrugated stock is disposed on the outer peripheral surface of the erected structural support member, greater rigidity is provided to the structural support member.

The structural support member may be made collapsible and/or erectable by any methods known in the art or otherwise contemplated herein. In one non-limiting example, the structural support member is formed of a substantially flat sheet of material that has a first end and a second end. The structural support member formed in this manner is erected by bringing the first and second ends together and securing the first and second ends to one another. The ends may be secured to one another by any methods known in the art or otherwise contemplated herein. For example, one or both of the first and second ends may have a bonding material (such as, but not limited to, an adhesive or cohesive) disposed thereon. Alternatively, the two ends may be stapled together or otherwise secured by similar methods. The two ends may overlap one another when secured, or the two ends may abut one another when secured. The structural support member formed of a substantially flat sheet of material may further contain one or more condition modifying elements (such as, but not limited to, score lines) that assist in forming the structural support member into the desired shape and configuration.

In another non-limiting example, the structural support member is formed in an intact condition with a receiving space formed therein, whereby the structural support member can be collapsed (if not formed in a collapsed condition) for packaging and/or distribution thereof prior to use as part of a packaging/shipping apparatus. The structural support member may be collapsed by any manner known in the art or otherwise contemplated herein. In addition, the structural support member may contain one or more condition modifying elements (such as, but not limited to, score lines) that assist in collapsing the structural support member from the erect condition.

When a structural support member is provided with condition modifying element(s) for the purposes of erecting and/or collapsing the structural support member, the number of condition modifying elements present may vary. For example, when the structural support member is formed in an intact condition, one or two score lines may be sufficient to cause collapse of the structural support member. Alternatively, when the structural support member is formed of a substantially flat sheet of material, the structural support member may be provided with a certain number of condition modifying elements that corresponds to the desired cross section of the erected structural support member and facilitates the structural support member in assuming the desired shape and configuration. In one particular embodiment, the shape assumed by the erected structural support member has a polygonal cross-section, and the number of condition modifying elements generally corresponds to the number of sides of the polygonal cross-section. For example, when the structural support member has an octagonal cross section in the erect condition, the structural support member may contain seven or eight score lines (depending on whether or not there is any overlap between segments).

However, it is to be understood that the presently disclosed and/or claimed inventive concept(s) is not limited to these two examples described herein above; the scope of the presently disclosed and/or claimed inventive concept(s) encompasses the presence of any number of condition modifying elements.

When in the erect condition, the structural support member may assume any desired shape and configuration. For example, but not by way of limitation, the structural support member may assume any three dimensional shape known in the art, including shapes that are identical to or substantially or generally similar to a cylinder, a cone, a sphere, a polyhedron, or a prism, as well as any variation thereof (such as a tapered or frusto-conical shape) and/or any combination thereof. The structural support member may also be provided with any cross-sectional shape known in the art, including but not limited to, shapes that are identical to or substantially or generally similar to square, rectangular, oval, round, elliptical, triangular, or polygonal, as well as any variation and/or combination thereof. In particular embodiments, the cross-section is a polygonal shape having between two and twenty-five sides (including, but not limited to, shapes selected from the group consisting of pentagon, hexagon, heptagon, septagon, octagon, nonagon, decagon, and the like).

The structural support members of the presently disclosed and/or claimed inventive concept(s) may be sized and shaped for use with specific containers (such as, but not limited to, preformed flower pot cover or containers for floral groupings). Alternatively, the structural support members may possess a more generic size and shape that allows for their use with multiple types and/or sizes of containers.

The structural support members described or otherwise contemplated herein are designed for use with a platform to form a packaging/shipping apparatus. The structural support members may be utilized with any existing shipping apparatus known in the art; for example, but not by way of limitation, the structural support members may be utilized in place of the stacking shells of the containers/devices disclosed in the following patents: U.S. Pat. No. 6,122,896, issued Sep. 26, 2000 to Weder et al.; U.S. Pat. No. 6,405,871, issued Jun. 18, 2002 to Craig et al.; U.S. Pat. No. 6,725,627, issued Apr. 27, 2004 to Weder et al.; and U.S. Pat. No. 7,836,665, issued Nov. 23, 2010 to Weder. The entire contents of the above-referenced patents are hereby expressly incorporated herein by reference.

In certain embodiments, the presently disclosed and/or claimed inventive concept(s) includes an apparatus for use in the packing, shipping, and/or storing of a stack of containers. The apparatus includes a platform and one or more structural support members associated with at least one surface of the platform (such as, but not limited to, an upper surface, a lower surface, and/or a side surface thereof). Any of the structural support members described herein above or otherwise contemplated herein may be utilized as the structural support member(s) of the apparatus. In one particular embodiment, the apparatus includes a plurality of structural support members associated with the platform; in this embodiment, the plurality of structural support members may all be of the same size and/or shape, or the plurality of structural support members may include two or more different sizes and/or shapes of structural support members.

In one embodiment, the platform may be a pallet, such as, but not limited to, a conventional wooden platform constructed of a plurality of slats connected to a plurality of feet or cross members in a spaced apart, coplanar relationship so as to form an upper planar surface. The cross members may be arranged in a perpendicular relationship relative to the slats and may be provided with a pair of fork receiving slots to facilitate movement of the shipping apparatus with a fork lift (not shown). In addition to wood, it will be understood that the pallet can be constructed of any other suitable material, such as, but not limited to, plastic.

In another embodiment, the platform may be in the form of a substantially flat sheet of material commonly known as a slip sheet. Slip sheets are typically manufactured of cardboard, but can be manufactured of any material that allows the slip sheet to function in accordance with the presently disclosed and/or claimed inventive concept(s), including but not limited to, wood, metal, and/or plastic. In addition, the slip sheet may be provided with scored area(s) around the perimeter thereof that form flaps that can be folded upward and assist the structural support member(s) in supporting the containers in a stable condition.

There may be some instances where it may be advantageous to use a slip sheet rather than a pallet. For example, slip sheets typically do not require fumigation during the export process, but fumigation is sometimes required when pallets are used. In addition, slip sheets are typically thinner than a pallet (for example, but not by way of limitation, ¼″ thick for a slip sheet compared to 2-4″ thick for a pallet). Thus, in certain instances, more actual product may be placed in the same area when a slip sheet is used. However, it is to be understood that the scope of the presently disclosed and/or claimed inventive concept(s) includes not only the use of slip sheets as well as pallets, but also any other type of platform known or otherwise contemplated within the art and capable of functioning as described herein.

In certain embodiments, the structural support member(s) is attached to the platform. The structural support members may be attached to the platform by any method known in the art or otherwise contemplated herein and utilizing any attachment element known in the art of otherwise contemplated herein. Non-limiting examples of attachment elements that may be utilized include staples, screws, nuts and bolts, adhesive, cohesive, combinations thereof, and the like. In addition, the structural support members may include at least one flap attached to the bottom thereof that facilitates attachment of the structural support member to the platform.

In certain other embodiments, the structural support member(s) may not be attached to the platform. In yet another embodiment, multiple structural support member(s) may be in association with the platform, and at least one of the structural support member(s) may be attached to the platform while at least one structural support member(s) is not attached to the platform.

In another embodiment of the presently disclosed and/or claimed inventive concept(s), the apparatus further comprises at least one stabilizing element associated with the platform, wherein the at least one stabilizing element stabilizes stack(s) of containers disposed upon the apparatus and reduces and/or minimizes shifting, leaning, and/or instability of the stack(s) of containers. In one particular embodiment, the at least one stabilizing element functions to substantially minimize and/or prevent the stack(s) of containers from exceeding a footprint of the platform.

In another embodiment of the presently disclosed and/or claimed inventive concept(s), the apparatus further comprises at least one stacking element that allows for the stacking of multiple apparatuses one on top of the other. A first apparatus may be provided with the at least one stacking element that comprises a platform receiving surface that allows the first apparatus to receive a second apparatus so that it is stacked on top of the first apparatus. In this manner, the platform of the second apparatus may contact at least a portion of the at least one platform receiving surface of the first apparatus. In addition, the at least one stacking element may be utilized with a single apparatus that is disposed on the platform receiving surface thereof. In this manner, a lower end of the stacking element may be disposed on a surface, such as, but not limited to, the floor or other surface of a trailer, the floor or other surface of a packaging facility, the floor or other surface of a storage facility, and the like.

In certain embodiments, the stabilizing element(s) and/or stacking element(s) may be attached to the platform. Alternatively, the stabilizing element(s) and/or stacking element(s) may not be attached to the platform. The stabilizing element(s) and/or stacking element(s) may also extend from the platform, such as, but not limited to, in a vertical, horizontal, angular, and/or oblique direction. In addition, a structure may be provided that contains two portions, wherein one portion functions as a stabilizing element, and another portion functions as a stacking element. Alternatively, portions of a structure may function as both a stabilizing element and a stacking element.

In one non-limiting example (and as depicted in FIG. 15, as described in further detail herein below), the stacking element may include four posts that are attached or otherwise associated with the platform near the four corners thereof. These four posts may form the platform receiving surface that supports an apparatus disposed thereon. Alternatively, the four posts may be connected by one or more members that provide further stability to the platform receiving surface. One or more of the four posts (and/or one or more of the additional connecting members) may also function as a stabilizing element. One or more pairs of the four posts may also have one or more members that extend diagonally therebetween that function as stabilizing elements. These diagonally extending members may also provide additional support to the stacking element.

In one embodiment, the stacking element is a rigid or semi-rigid structure (although the stacking element may be formed of one or more flexible materials that form a rigid or semi-rigid structure) that stabilizes at least a portion of a stack of covers between the top of the structural support members and the top of the stack of covers. The stabilizing element provides greater stability to the stack of covers disposed on the apparatus than the prior art methods, such as those disclosed in U.S. Pat. No. 6,122,896; U.S. Pat. No. 6,405,871; and U.S. Pat. No. 6,725,627; all of which were previously incorporated herein by reference.

It is to be understood that the stacking elements and stabilizing elements disclosed herein are not limited to use with the apparatus containing the structural support members of the presently disclosed and/or claimed inventive concept(s). Indeed, either or both of the stacking elements and stabilizing elements of the presently disclosed and/or claimed inventive concept(s) can be utilized with any other apparatuses known in the prior art or otherwise contemplated by a person of ordinary skill in the art, including but not limited to, the apparatuses disclosed in the '896, '871, and '627 patents incorporated herein.

Another embodiment of the presently disclosed and/or claimed inventive concept(s) is directed to a method of packing, shipping, and/or storing a stack of containers. In the method, at least one of any of the structural support members described or otherwise contemplated herein is moved from a collapsed condition to an erect condition and disposed on a surface of a platform to form any of the apparatuses described or otherwise contemplated herein above. At least one stack of containers (such as, but not limited to, at least one stack of nested floral containers) is then disposed on the apparatus so that one or more structural support members stabilizes the at least one stack of containers and reduces and/or minimizes shifting, leaning, and/or instability of the at least one stack of containers. The at least one stack of containers is disposed on the apparatus so that: (a) the outer peripheral surface of the structural support member contacts at least a portion of a peripheral surface of a terminal floral container in the stack of floral containers, and/or (b) the receiving space of the structural support member receives at least a portion of a terminal floral container in the stack of floral containers. The at least one stack of containers may be disposed on the apparatus in any orientation known in the art or otherwise contemplated herein (including, but not limited to, an upright or inverted orientation).

In a particular embodiment of the method, a plurality of structural support members are utilized; each of the plurality of structural support members is moved from a collapsed condition to an erect condition and disposed on a surface of a platform to form the apparatus. When multiple structural support members are utilized, the plurality of structural support members may all be of the same size and/or shape, or the plurality of structural support members may include two or more different sizes and/or shapes of structural support members.

In addition, two or more stacks of containers may be disposed on the apparatus so that the plurality of structural support members stabilizes the two or more stacks of containers and reduces shifting, leaning, and/or instability of the two or more stacks of containers. When multiple stacks of containers are present, the containers may have the same size and/or shape; alternatively, the containers present in one stack may have a different size and/or shape than the containers in another stack. Further, a single stack of containers may include different sizes and/or shapes of containers.

The plurality of stacks of containers may be disposed on the apparatus such that they are oriented in the same direction, or one stack of containers may be oriented in a different direction than another stack of containers. For example, the containers in one or more stacks may be oriented in an upright direction (i.e., openings up), or the containers in one or more stacks may be oriented in an inverted direction (i.e., such that the openings in the containers face downward). Alternatively, one or more stacks of containers may be oriented in an upright orientation while another one or more stacks of containers may be oriented in an inverted orientation. In addition, the containers may be stacked in any other orientation or combination of orientations, so long as the presently disclosed and/or claimed inventive concept(s) can function as described herein.

Once the stack(s) of containers are disposed on the structural support member(s) disposed on the platform, it may be desired to secure the stack(s) of containers to the apparatus. When the stack(s) of containers are secured to the apparatus, they may be secured by any method known in the art or otherwise contemplated herein. In one non-limiting example, the stack(s) of containers are secured to the apparatus by wrapping a securing element about the periphery of the stack(s) of containers and at least a portion of the apparatus. In addition, the securing element may further serve to protect the containers from dirt and water damage during the shipping and storage process. In instances when greater stability may be desired, the securing element may also be wrapped over the top of the stack(s) of containers and/or around and/or between any additional support devices that may be present.

Any material capable of functioning as a securing element as described herein falls within the scope of the presently disclosed and/or claimed inventive concept(s). Non-limiting examples thereof are described herein above. In addition, in certain particular embodiments, the securing element may be substantially transparent so as to permit inspection of the containers without requiring the securing element to first be removed.

The presently disclosed and/or claimed inventive concept(s) further includes a packaged unit formed by any of the methods described herein above or otherwise contemplated herein. Thus, the packaged unit includes an apparatus comprising a platform and one or more structural support members associated therewith, and one or more stacks of containers disposed on the apparatus. The packaged unit may further comprise at least one stabilizing element, at least one stacking element, and/or at least one securing element.

In another embodiment of the methods of the presently disclosed and/or claimed inventive concept(s), two packaged units are formed by the method steps described herein above (or by any other method known or otherwise contemplated in the art, including by the methods of the '896, '871, and '627 patents incorporated herein, or by any combination of the prior art methods and the methods of the presently disclosed and/or claimed inventive concept(s)). In this particular embodiment of the method, the apparatus of the first packaged unit includes at least one stacking element having at least one platform receiving surface (as described in detail herein above), and the second packaged unit is stacked on top of the first packaged unit. In this manner, the platform of the second packaged unit contacts at least a portion of the at least one platform receiving surface of the apparatus of the first packaged unit.

Another embodiment of the presently disclosed and/or claimed inventive concept(s) includes a kit that includes at least one of the structural support members described herein above or otherwise contemplated herein. The kit may further include instructions for associating the at least one structural support member with a platform to form an apparatus for use in the packing, shipping, and/or storing of at least one stack of floral containers. In a particular embodiment, the kit includes a plurality of structural support members; the plurality of structural support members may be provided with the same shape and/or size, or the plurality of structural support members may be provided with two or more different shapes and/or sizes.

The kit may further include separate components for use in the methods described or otherwise contemplated herein. For example, but not by way of limitation, the kit may include at least one platform, at least one stabilizing element, at least one stacking element, and/or at least one securing element.

The kit may include the required components for forming a single apparatus, or the kit may include additional components that allow for multiple apparatuses to be formed. In addition, when the kit includes enough components for forming multiple apparatuses, the kit may be specifically designed to include components for forming at least two apparatuses wherein one apparatus may be stacked upon another apparatus (i.e., by including at least one stacking apparatus having at least one platform receiving surface (as described in detail herein above)).

In certain embodiments, separate and/or unattached elements of the kit may be associated with one another via a packaging. The term “packaging” as used herein will be understood to include any element(s) that associate the content(s) of the kits contemplated herein with one another. Non-limiting examples of packaging that may be utilized in accordance with the presently disclosed and/or claimed inventive concept(s) include a bag, a wrapper, adhesive, cohesive, tape, a flexible container, a rigid container, stretch wrap, shrink wrap, and combinations thereof.

Another embodiment of the presently disclosed and/or claimed inventive concept(s) is directed to a packaged unit that includes an apparatus comprising at least one structural support member associated with at least one surface of a platform. The at least one structural support member may be as described or otherwise contemplated herein; alternatively, any other structural support members known in the art may be utilized in this embodiment. The packaged unit also includes at least two stacks of containers (such as, but not limited to, at least two stacks of nested floral containers) disposed on and supported by the apparatus, wherein at least one of the stacks of floral containers is supported in an upright orientation and at least one of the other stacks of floral containers is supported in an inverted orientation. One advantage of this packaged unit is that the space of the apparatus occupied by the at least two stacks of floral containers is less than a space of the apparatus that would be occupied if the at least two stacks of floral containers were oriented in the same direction.

In a particular embodiment, the apparatus includes a plurality of structural support members. When a plurality of structural support members are present, the plurality of structural support members may be provided with the same shape and/or size; alternatively, the plurality of structural support members may be provided with two or more different shapes and/or sizes.

In addition, the apparatus may further include at least one stabilizing element as described in detail herein above. Further, the apparatus may include at least one stabilizing element to facilitate stacking of multiple packaged units. Thus, the presently disclosed and/or claimed inventive concept(s) includes a packaged unit formed of two packaged units as described herein above, wherein a first packaged unit is provided with the stacking element having a platform receiving surface. The second packaged unit is stacked on top of the first packaged unit, whereby the platform of the second packaged unit contacts at least a portion of the stacking element of the apparatus of the first packaged unit (such as, but not limited to, a platform receiving surface thereof).

Another embodiment of the presently disclosed and/or claimed inventive concept(s) is directed to a method of packaging a plurality of nested objects in a container, wherein the number of nested objects in the container has been maximized. In the method, the longest limiting dimension of the container capable of accommodating the length and width of the object is determined, and an axis of nesting of at least one stack of nested objects is oriented in substantially the same plane as the longest limiting dimension of the container to minimize the number of stacks of nested objects in the container. A maximum number of objects is placed in at least one stack of nested objects, and the at least one stack of nested objects is disposed within the container.

The method may further include the step of stabilizing the at least one stack of nested objects within the container. In one non-limiting example, the at least one stack is stabilized by disposing within the container at least one structural support member and/or at least one stabilizing element. The at least one structural support member/stabilizing element supports and stabilizes the at least one stack of nested objects within the container so as to minimize damage thereto. Any structural support member or stabilizing element previously known in the art or described or otherwise contemplated herein may be utilized in accordance with this embodiment of the presently disclosed and/or claimed inventive concept(s).

In particular embodiments of this method, the axis of nesting is a vertical dimension of the container. In other embodiments, the axis of nesting is a horizontal dimension of the container. In addition, it is noted that a volume occupied per each nestable object divided by the number of objects in a stack varies inversely with the number of objects present in a single stack. Thus, by maximizing the number of nested objects in each stack, the package can be designed and configured for optimal use.

While examples of sequences of method steps are provided herein, it is to be understood that the method steps, as well as the order of the steps, may vary. Any combination of method steps and sequences thereof may be utilized so long as the devices and/or apparatuses described herein are capable of functioning in accordance with the presently disclosed and/or claimed inventive concept(s).

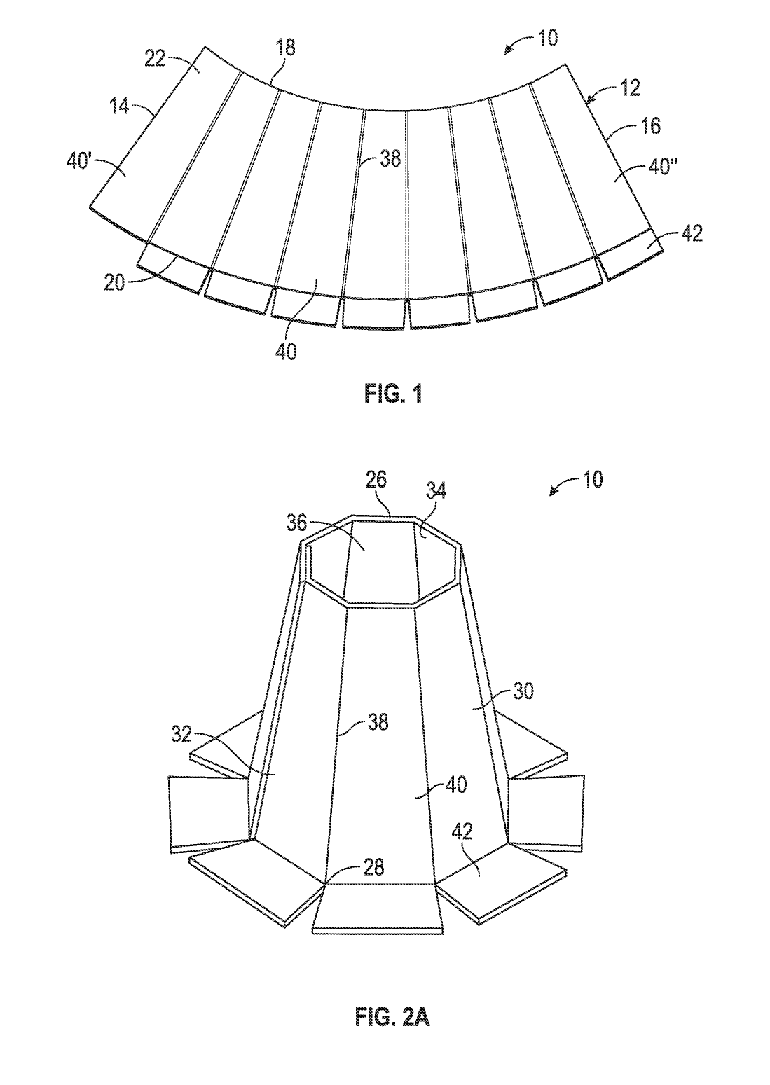

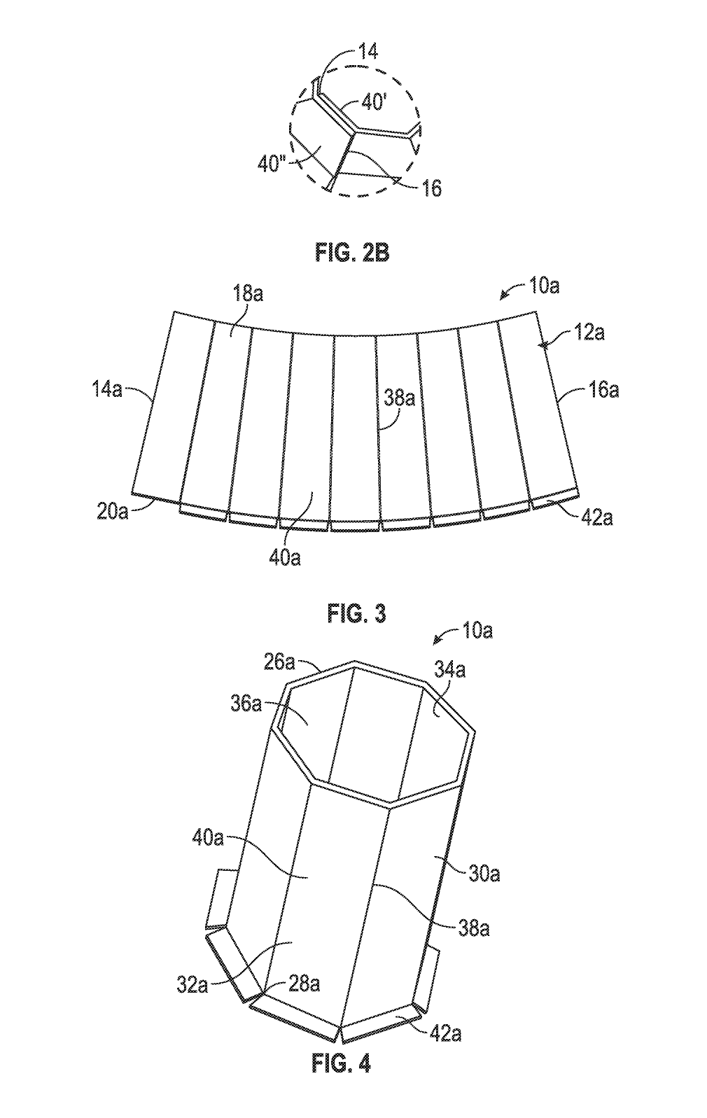

Turning now to the Drawings, FIGS. 1 and 2 illustrate one embodiment of a structural support member constructed in accordance with the presently disclosed and/or claimed inventive concept(s). FIG. 1 illustrates the structural support member in a substantially flattened condition, while FIG. 2A illustrates the structural support member in an erect condition. The structural support member is indicated in the Figures by reference numeral 10 and is formed of a substantially flat sheet of material 12, as shown in FIG. 1. The sheet of material 12 has a first edge 14, a second edge 16, a first end 18, a second end 20, a first surface 22, and a second surface 24. In particular, the sheet of material 12 is shown as having a substantially trapezoidal shape; however, the sheet of material 12 may be provided with any configuration, so long as the sheet of material 12 can form a structural support member 10 that can function in accordance with the presently disclosed and/or claimed inventive concept(s). FIG. 2A illustrates the sheet of material 12 being formed into an erected structural support member 10.

As shown in FIG. 2A, the erected structural support member 10 has an upper end 26, a lower end 28, and a sidewall 30. The sidewall 30 has an outer surface 32 and an inner surface 34, wherein the inner surface 34 defines an inner space 36 that extends substantially from the upper end 26 to the lower end 28 of the structural support member 10.

In certain embodiments, the sheet of material 12 has one or more score lines 38 formed therein that function to assist the sheet of material 12 in the folding thereof and thus the erection of the structural support member 10. The one or more score lines 38 separate the sheet of material 12 into two or more panels 40, and these panels 40 form the sidewall 30 of the structural support member 10. In the formation of the structural support member 10, the sheet of material 12 is folded slightly along each of the score lines 38 to assume a somewhat frusto-conical configuration. The first and second edges 14 and 16 of the sheet of material 12 are brought into relatively close proximity to one another in the erection of the structural support member 10. The first and second edges 14 and 16 may abut one another during the formation of the structural support member 10, or the first and second edges 14 and 16 may overlap one another during the formation of the structural support member 10. For example, but not by way of limitation, as shown in FIG. 2B, a panel 40′ that contains the first edge 14 on an end thereof may overlap and be associated with a panel 40″ that contains the second edge 16 on an end thereof. Alternatively, a panel 40 containing one of the first and second edges 14 and 16 may overlap and be associated with a panel 40 that is directly or indirectly attached to a panel 40 containing the other edge 14 or 16. By moving the association points in this manner, the size of the structural support member 10 can be varied, and a single sheet of material 12 can be used to produce multiple structural support members 10 having varying widths and thus can be used for different purposes and to support different containers.

While FIG. 1 illustrates the sheet of material 12 as having eight score lines 38 and nine panels 40, and FIG. 2A illustrates that the sheet of material 12 is formed into the structural support member 10 having a substantially octagonal shape with eight panels 40 exposed on the sidewall 30 thereof, it will be understood that the presently disclosed and/or claimed inventive concept(s) is not limited to this particular configuration. The scope of the presently disclosed and/or claimed inventive concept(s), includes the use of any number of score lines 38 and panels 40, as well as the formation of any desired polygonal shape for the sidewall 30, so long as the structural support member 10 can function as described and/or claimed herein. In addition, it will be understood that a single sheet of material 12 can be formed into multiple structural support members 10 having different polygonal shapes for the sidewalls 30 thereof, depending on the amount of overlap between panels 40. For example, but not by way of limitation, if three of the panels 40 of FIG. 1 overlapped in the formation of the structural support member 10 (i.e., the panel 40′ containing the first edge 14 overlaps with a panel 40′″ that is interior to the panel 40″ containing the second edge 16), the sidewall 30 of the structural support member 10 would have a substantially heptagonal shape; if four of the panels 40 overlapped, the sidewall 30 of the structural support member 10 would have a substantially hexagonal shape; etc.

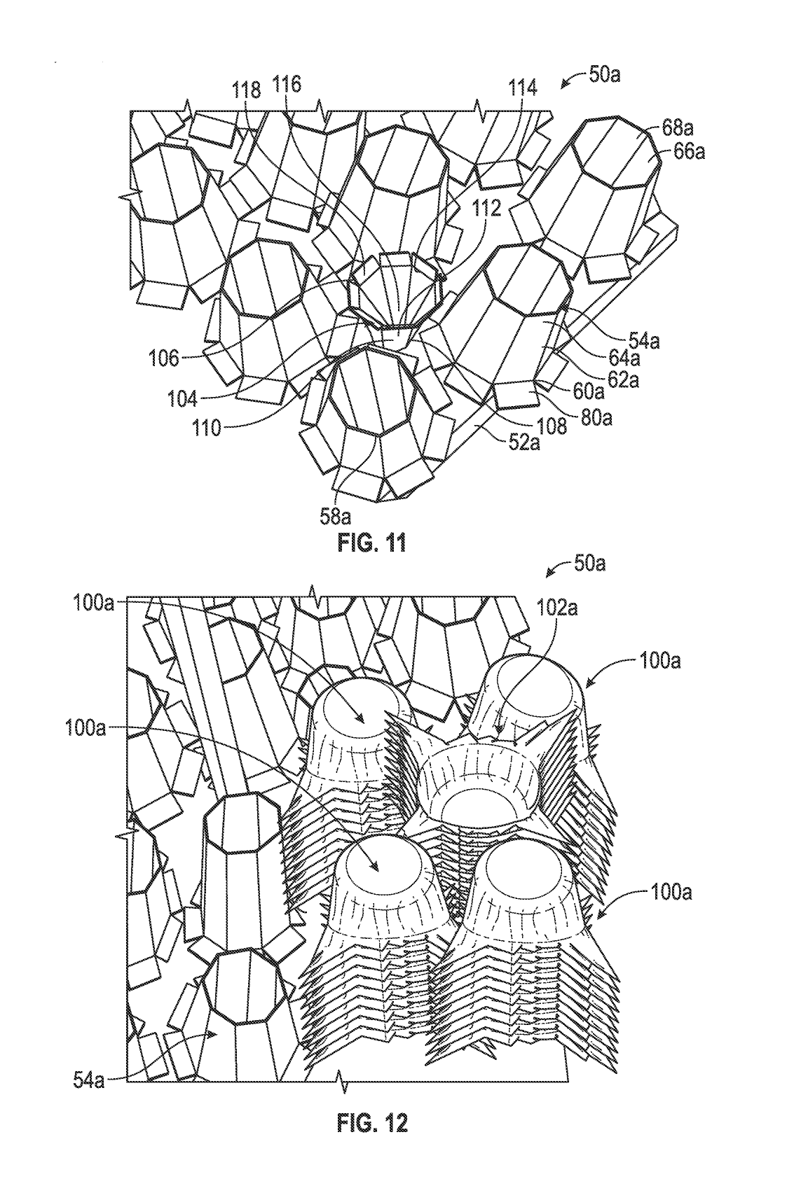

In certain embodiments, the second end 20 of the sheet of material 12 is provided with one or more flaps 42 extending therefrom. The one or more flaps 38 may perform different functions, depending on the orientation in which the structural support member 10 is used. In certain embodiments (and in the orientation shown in FIG. 2A), the first end 18 of the sheet of material 12 forms the upper end 26 of the structural support member 10, while the second end 20 of the sheet of material 21 forms the lower end 28 of the structural support member 10. In this embodiment, the one or more flaps 42 may be utilized to attach the lower end 28 of the structural support member 10 to a platform. In an alternative embodiment (and as discussed in detail herein below with reference to FIG. 11), the first end 18 of the sheet of material 12 forms the lower end 28 of the structural support member 10, while the second end 20 of the sheet of material 21 forms the upper end 26 of the structural support member 10. In this embodiment, the one or more flaps 42 may be utilized to provide support to one of more containers, wherein at least a portion of the one or more containers is disposed in at least a portion of the inner space 36 of the structural support member 10.

While FIGS. 1 and 2A depict flaps 42 that correspond to each of the panels 40 of the structural support member 10 (with the exception of panel 40′), it should be understood that the flaps 42 do not have to correspond with each panel 40; indeed, the presently disclosed and/or claimed inventive concept(s) encompasses the presence of a single flap 42 as well as the presence of multiple flaps 42 (wherein the number thereof may be more than or less than the number of panels 40 present in the structural support member 10).

Therefore, in certain embodiments, one or more of the panels 40 may not have a flap 42 attached thereto. For example, but not by way of limitation, a panel 40 that will overlap another panel 40 may not be provided with a flap 42 attached thereto. As shown in FIGS. 1 and 2A, the panel 40′ that overlaps with panel 40″ does not have a flap 42 attached thereto. This prevents overlap of two flaps 42 in response to the overlap of two panels 40, and thus minimizes the amount of material present attached to the lower end 28 of the structural support member 10 and provides a more consistent configuration thereto.

FIG. 1 illustrates the first end 18 and the second end 20 of the sheet of material 12 as being slightly curved; in this manner, when the sheet of material 12 is formed into the structural support member 10, the curved ends 18 and 20 provide the upper and lower ends 26 and 28 of the structural support member 10 with a substantially flat, planar surface. In addition, FIG. 1 illustrates the first end 18 as having a length that is less than a length of the second end 20; in this manner, the structural support member 10 assumes a somewhat frusto-conical configuration.

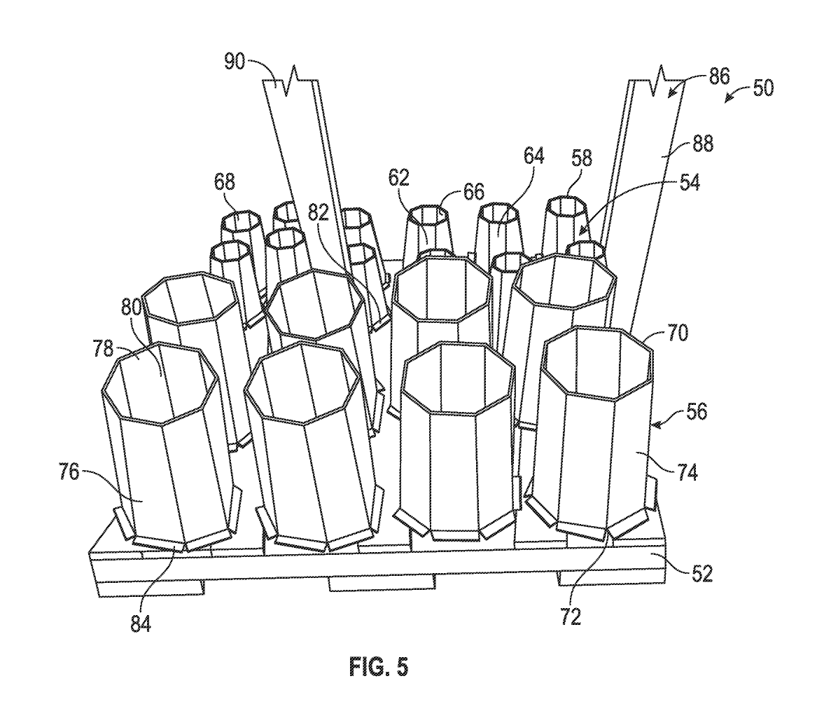

Shown in FIG. 3 is a substantially flat sheet of material 12a that is used in the formation of a structural support member 10a, as shown in FIG. 4. The sheet of material 12a is identical to the sheet of material 12, except as described herein below. A first end 18a of the sheet of material 12a has a length that is similar to (and only slightly less than) a length of a second end 20a thereof (as compared to the first end 18 of the sheet of material 12 of FIG. 1, which has a length that is substantially less than a length of the second end 20 thereof); in this manner, the structural support member 10a formed therefrom assumes a more conical configuration, as shown in FIG. 4. In addition, the first end 18a and the second end 20a of the sheet of material 12a are provided with less of a curve as compared to first and second ends 18 and 20 of the sheet of material 12 of FIG. 1. This this adjustment in angle cooperates with the adjustments to the lengths of the first and second ends 18a and 20a to provide the structural support member 10a with an upper end 26a (formed from the first end 18a of the sheet of material 12a) and a lower end 28a (formed from the second end 20a of the sheet of material 12a), wherein the upper and lower ends 26a and 28a each have a substantially flat, planar surface.

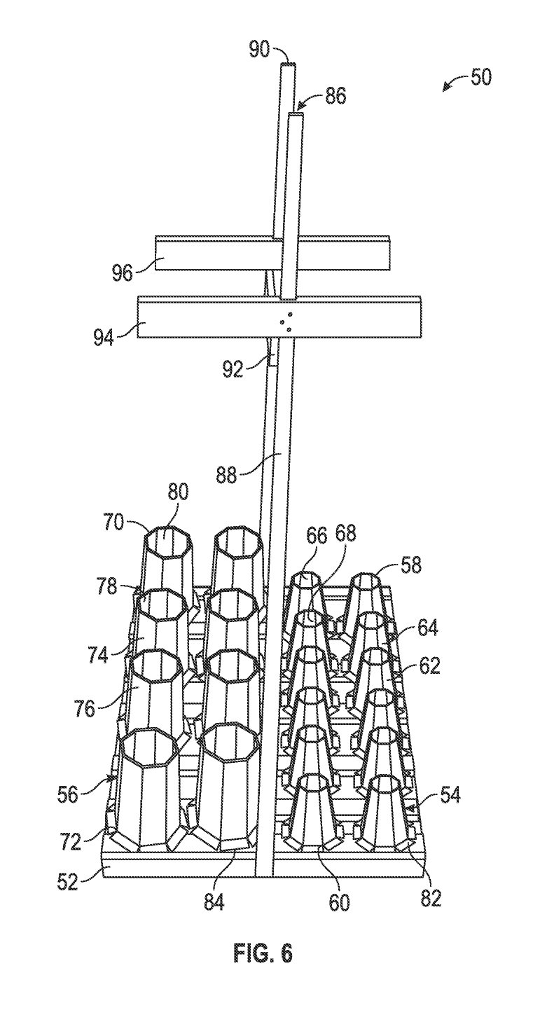

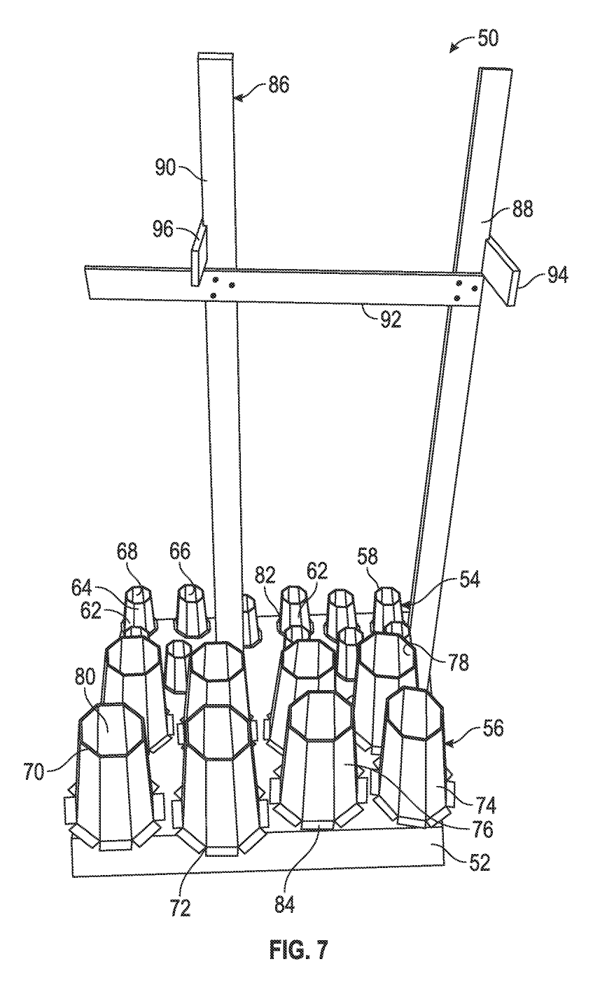

FIGS. 5-7 illustrate one embodiment of an apparatus constructed in accordance with the presently disclosed and/or claimed inventive concept(s). The apparatus is designated herein by the reference numeral 50 and includes a platform 52 and a plurality of structural support members attached thereto. For the purposes of illustration only, the platform 52 is illustrated as having a plurality of first structural support members 54 attached thereto and a plurality of second structural support members 56 attached thereto; however, it will be understood that the apparatus 50 may include only a single type of structural support member, or may include three or more types of structural support members. The first structural support members 54 are illustrated as having a shape and configuration similar to the structural support member 10 of FIGS. 2A-B, and having an upper end 58, a lower end 60, and a sidewall 62 having an outer surface 64 and an inner surface 66 defining an inner space 68. The second structural support members 56 are illustrated as having a shape and configuration similar to the structural support member 10a of FIG. 4, and having an upper end 70, a lower end 72, and a sidewall 74 having an outer surface 76 and an inner surface 78 defining an inner space 80. However, it is to be understood that the structural support members 54 and 56 may be any of the structural support members disclosed or otherwise contemplated herein and thus may assume any shape and configuration that allows the structural support members to function in accordance with the presently disclosed and/or claimed inventive concept(s).

Each of the structural support members 54 has one or more flaps 82 extending from the lower end 60 thereof (i.e., similar to the flaps 42 of the structural support member 10 of FIGS. 2A-B), while each of the structural support members 56 has one or more flaps 84 extending from the lower end 72 thereof (i.e., similar to the flaps 42a of a structural support member 10a of FIG. 4). One or more of the flaps 82 and 84 function to attach the structural support members 54 and 56, respectively, to the platform 52. The flaps 82 and 84 may be attached to platform 52 by any methods known in the art or otherwise contemplated herein. Methods of attaching a material to a platform are well known in the art and knowledge of a person having ordinary skill in the art; thus, no further discussion thereof is deemed necessary.

The apparatus 50 further includes a stabilizing element 86; the stabilizing element 86 functions to stabilize one or more containers supported by one or more of the structural support members 54 and/or 56 and on the platform 52. The stabilizing element 86 is illustrated in FIGS. 5-7 as including a first vertically-extending member 88 and a second vertically-extending member 90 that extend substantially vertically from the platform 52 and are spaced a distance apart from one another. The stabilizing element 86 is illustrated as further including a first horizontally-extending member 92 that extends above the upper end 58 of each of the structural support members 54 and the upper end 70 of each of the structural support members 56, and a second horizontally-extending member 94 and a third horizontally-extending member 96 that each extend parallel to one another and perpendicular to the first horizontally-extending member 92 (and also above the upper ends 58 and 70 of each of the first and second structural support members 54 and 56, respectively). In addition, the first horizontally-extending member 92 and the two vertically-extending members 88 and 90 are illustrated as being substantially planar to each other in a vertical plane, while the second and third horizontally-extending members 94 and 96 are illustrated as extending substantially perpendicular to each of the vertically-extending members 88 and 90 in the vertical plane.

It is to be understood that the configuration of the stabilizing element 86 shown in FIGS. 5-7 is for the purposes of illustration only. The presently disclosed and/or claimed inventive concept(s) is not limited to the particular structural design and relation to other components as shown in FIGS. 5-7; indeed, any structure (including any number of vertically-extending, horizontally-extending, and/or otherwise-extending members) may be utilized for the stabilizing element 86, as long as the stabilizing element 86 can be associated with the platform 52 and function as described in detail herein.

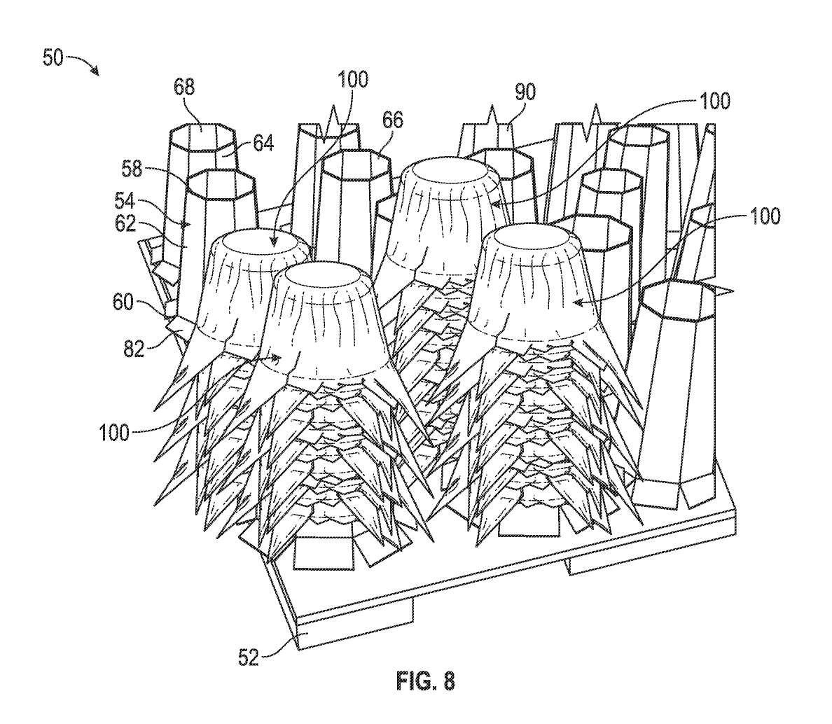

FIG. 8 illustrates use of the apparatus 50 to support multiple stacks of containers 100 (four stacks being shown for the purposes of illustration only). In the packaged unit shown in FIG. 8, each of the stacks of containers 100 is supported in an inverted orientation on one of the structural support members 54 of the apparatus 50.

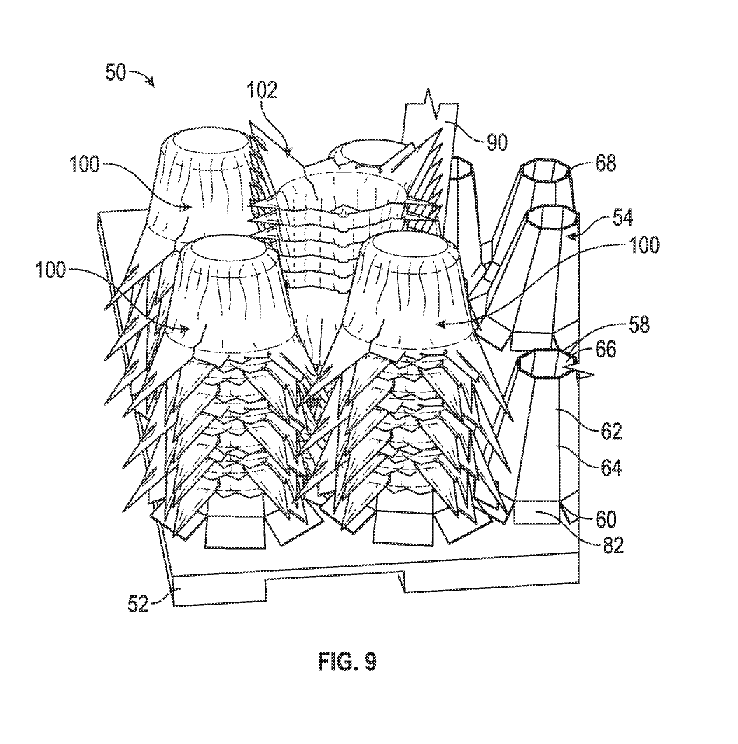

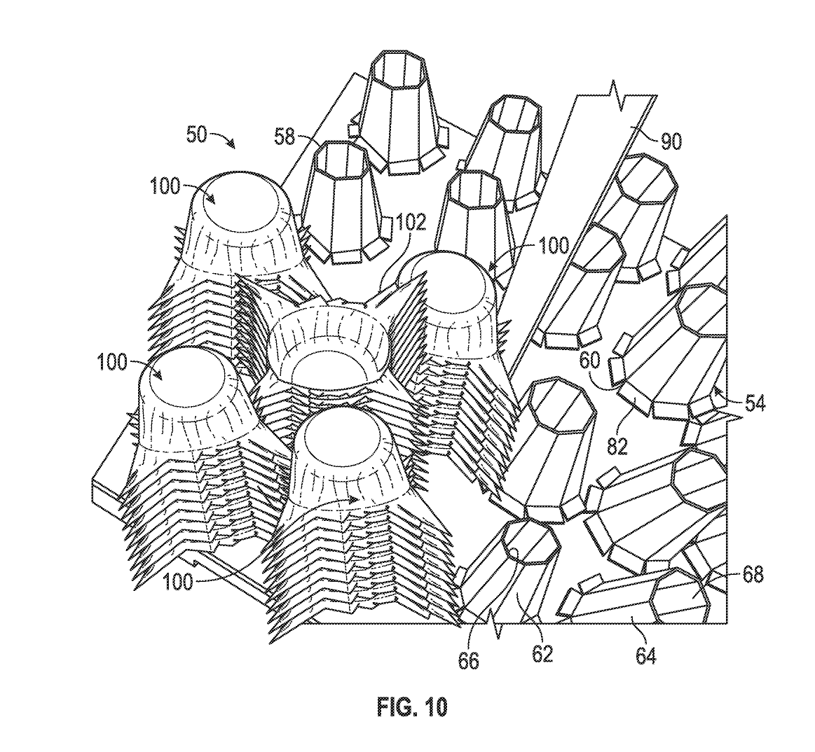

FIGS. 9-10 illustrate an additional, optional use of the apparatus 50. The packaged unit of FIGS. 9-10 is similar to the packaged unit of FIG. 8, wherein multiple stacks of containers 100 (four stacks being shown for the purposes of illustration only) are each supported in an inverted orientation on one of the structural support members 54 of the apparatus 50. The packaged unit also includes the presence of at least one additional stack of containers 102. The stack of containers 102 is supported in an upright orientation in between the four stacks of containers 100. When the stacks of containers 100 are tapered covers and are stacked in the manner shown in FIG. 8 (i.e., the openings thereof face downward and the wider end thereof is disposed below a thinner end thereof), a space of sufficient width is formed between the stacks of containers 100. The number of containers 100/102 disposed on the pallet can be increased by filling in the spaces in between the stacks of containers 100. The addition of the stack of containers 102 opening in an opposite direction to the surrounding stacks of containers 100 will at least partially fill the void area formed in between the stacks of containers 100 and thus provide a greater density of containers 100/102 in a packaged unit (i.e., apparatus 50).

While FIGS. 9-10 illustrate the formation of a packaged unit utilizing the apparatus 50, it is to be understood that the presently disclosed and/or claimed inventive concept(s) is not limited in this manner. Indeed, the method of packaging containers wherein a portion of the containers are disposed in an inverted orientation while another portion of the containers is supported in an upright orientation therebetween, regardless of the apparatus/stacking devices used, also falls within the scope of the presently disclosed and/or claimed inventive concept(s). Therefore, the use of the apparatus 50 with the method shown in FIGS. 9-10 is not to be considered limiting.

In addition, the stack of containers 102 may simply be disposed in between the four stacks of containers 100 stacked in an opposite orientation. Alternatively, the apparatus may further include an additional structural support member that is disposed in between four of the structural support members that are supporting other stacks of containers. FIG. 11 depicts an apparatus 50a constructed in this manner, and FIG. 12 illustrates a packaged unit formed therefrom. The apparatus 50a includes at least four structural support members 54a disposed on a platform 52a such that they taper toward a larger diameter at a lower end thereof (and have flaps 82a on a lower end 60a thereof that facilitate attachment of the structural support members 54a to the platform 52a, as described in greater detail herein above). The apparatus 50a further includes another structural support member 104 disposed on the platform 52a in between two or more of the structural support members 54a (four structural support members 54a being shown in FIGS. 11-12 for purposes of illustration only). The additional structural support member 104 is similar in shape to any of the structural support members described or otherwise herein, except that the structural support member 104 has a configuration that is inverted when compared to the structural support members shown in FIGS. 1-10. The structural support member 104 has an upper end 106, a lower end 108, and a sidewall 110 having an outer surface 112 and an inner surface 114 that defines an inner space 116. The inner space 116 of the structural support member 104 is capable of receiving at least a portion of a lowermost container in the stack of containers 102a and thereby supporting the stack of containers 102a therein, either alone or in combination with the one or more stacks of containers 100a. The structural support member 104 may be provided with a configuration that substantially conforms to a shape of the containers 102a; for example, but not by way of limitation, the structural support member 104 is illustrated as being tapered from a smaller diameter at its lower end 108 to a larger diameter at its upper end 106. In addition, an upper portion of the sidewall 110 of the fifth structural support member 104 may have an outwardly extending angular surface that functions to support and/or protect the skirt portion of the container(s) 102a disposed therein. Alternatively and/or in addition thereto, the upper end 106 of the structural support member 104 may have one or more flaps 118 extending therefrom; in FIG. 11, the structural support member 104 is illustrated as having a plurality of flaps 118 extending outwardly therefrom so as to function to support and/or protect a skirt portion of the container(s) 102a disposed therein.

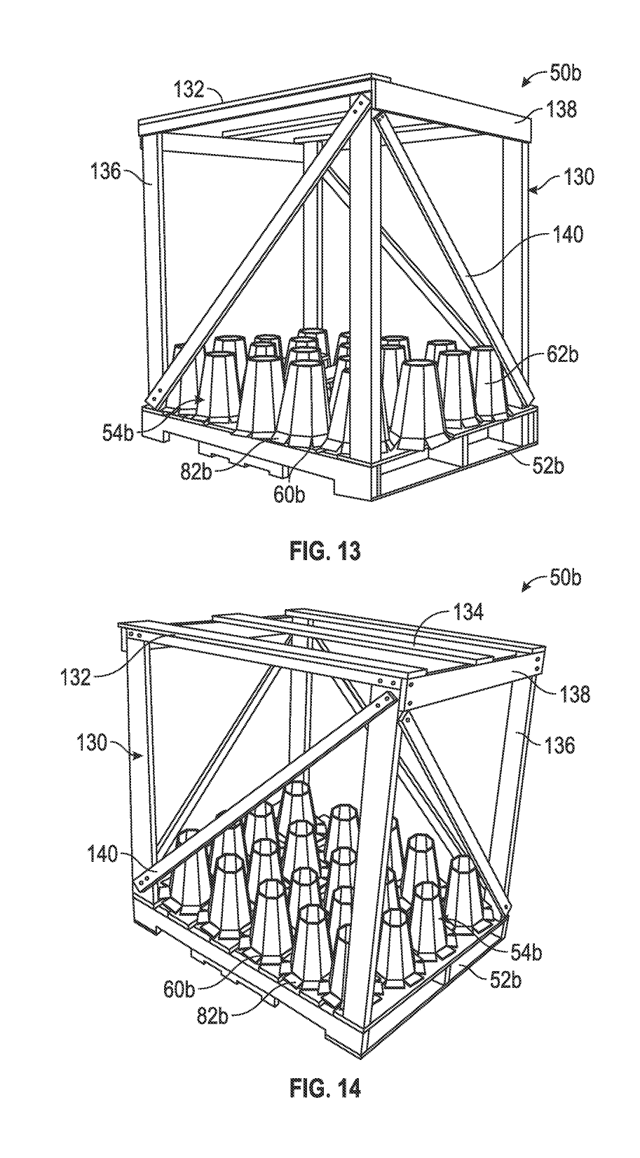

FIGS. 13-14 illustrate another embodiment of an apparatus constructed in accordance with the presently disclosed and/or claimed inventive concept(s). The apparatus is designated by the reference numeral 50b and is similar to the apparatus 50 of FIGS. 5-7, except as described herein below. The apparatus 50b includes a platform 52b and a plurality of structural support members 54b, each of which is attached to the platform 52b via one or more flaps 82b extending from a lower end 60b thereof. Note that a sidewall 62b of each of the structural support members 54b has a hexagonal shape, thus illustrating another configuration for the sidewalls of the structural support members disclosed or otherwise contemplated herein. The apparatus 50b further includes a stacking element 130 attached to the platform 52b. The stacking element 130 has an upper end 132 that provides a platform receiving surface 134 that is designed to engage a platform of an another apparatus that may be disposed thereon; the stacking element 130 is capable of supporting the weight of the upper apparatus (or packaged unit formed therefrom). The stacking element 130 is illustrated in FIGS. 13-14 as well as FIG. 15 (which illustrates the stacking element 130 alone) as including a plurality of vertically-extending members 136 that extend generally from the platform 52b to the upper end 132 of the stacking element 130. The stacking element 130 is also illustrated as including a plurality of horizontally-extending members 138 that extend generally between two or more of the vertically-extending members 136; three of the horizontally-extending members 138 are illustrated as cooperating to form the platform receiving surface 134. The stacking element 130 is further illustrated as including a plurality of diagonally-extending members 140, wherein one end of each of the diagonally-extending members 140 is associated with the platform 52b and/or a vertically-extending member 136 at a point substantially adjacent to the platform 52b; the other end of the diagonally-extending member 140 is associated with the upper end 132 of the stacking element 130 and/or one of the vertically-extending members 136 at a point substantially adjacent to the upper end 132. However, the configuration of the stacking element 130 shown in FIGS. 13-15 is for purposes of illustration only; any arrangement of members 136, 138, and/or 140, as well as any other structure capable of functioning in accordance with the presently disclosed and/or claimed inventive concept(s) may be utilized instead of the particular configuration shown in FIGS. 13-15.

In addition, the apparatus 50b may include a stabilizing element similar to the stabilizing element 86 of the apparatus 50 (as shown in FIGS. 5-7). Alternatively, one or more of the members 136, 138, and 140 of the stacking element 130 may also function as a stabilizing element in accordance with the presently disclosed and/or claimed inventive concept(s).

The stacking element 130 of FIG. 15 is shaped and designed to be utilized with a platform and at least one structural support member (including platforms and structural support members known in the art or disclosed herein) to form an apparatus in accordance with the presently disclosed and/or claimed inventive concept(s). As described herein above, the stacking element 130 includes a platform receiving surface 134 on the upper end 132 thereof that is designed to engage a platform of an apparatus stacked on top of the apparatus that contains the stacking element 130. In this manner, the stacking element 130 is capable of supporting the weight of the upper apparatus (or packaged unit formed therefrom). In addition, portions of the structure shown in FIG. 15 may function as a stabilizing element 86 and/or portions of the structure shown in FIG. 15 may be dual functioning as both stacking and stabilizing elements 130 and 86, respectively.

The stabilizing and/or stacking elements 86 and 130, respectively, may be associated with a platform by any method known in the art or otherwise contemplated herein. For example, but not by way of limitation, the stabilizing and/or stacking elements 86 and 130 may extend in between and/or around stacks of containers disposed on structural support members attached to a platform. A portion of the stabilizing and/or stacking elements 86 and 130 may be attached to the platform, or the stabilizing and/or stacking elements 86 and 130 may not be attached to the platform.

One of the advantages of stacking packaged units one on top of the other is that smaller orders can be shipped in a manner that fills the height of a trailer using fewer pallet spaces than would have otherwise been occupied using a partially-filled, full-size, single-stacked packaged unit. Another advantage of stacking packaged units in accordance with the presently disclosed and/or claimed inventive concept(s) is that items can be segregated in a packaged unit to facilitate handling and use by customers, as compared to using a packaged unit packed with a variety of items. Use of stacked packaged units facilitates full truck load shipments with various final destinations on one trailer to freight terminals or other sites to be cross docked and shipped to various customers.

While the stabilizing and/or stacking elements illustrated in the Figures are shown as having linear segments, it is to be understood that the presently disclosed and/or claimed inventive concept(s) is not limited to these particular embodiments; any element capable of functioning in accordance with the presently disclosed and/or claimed inventive concept(s) (i.e., by reducing shifting, leaning, and/or instability of packaged stacks, and/or by engaging the pallet of another apparatus and supporting the weight thereof), as well as any configuration thereof, also falls within the scope of the presently disclosed and/or claimed inventive concept(s). For example, but not by way of limitation, the stabilizing and/or stacking elements may include a piece of material (such as, but not limited to, cardboard) that has openings formed therein, each of the openings corresponding to a base of a flower pot cover in a stack of flower pot covers that is supported on a structural support member associated with the platform of the apparatus.

### EXAMPLES

Examples are provided hereinbelow. However, the presently disclosed and/or claimed inventive concept(s) is to be understood to not be limited in its application to the specific experimentation, results and laboratory procedures. Rather, the Examples are simply provided as one of various embodiments and are meant to be exemplary, not exhaustive.

### Example 1

FIG. 16A is a photograph of a packaged unit that includes an apparatus constructed as described herein above and that further includes a securing element (i.e., a shrink wrap or stretch film) wrapped about the apparatus that has a plurality of stacks of flower pot covers disposed thereon.

FIG. 16B depicts a comparison of the space occupied by a certain number of preformed flower pot covers packaged in accordance with the presently disclosed and/or claimed inventive concept(s) and packaged by the prior art traditional carton method. As shown, the apparatus of FIG. 16A is shown on the left side of the photograph and contains 31,200 6″ SPEED COVER® preformed flower pot covers (Highland Supply Corp., Highland, Ill.). To the right of said apparatus is the same amount of identical covers that have been packaged by the current carton method. As can be seen, the preformed flower pot covers packaged in cartons occupies more than three times the amount of space as the preformed flower pot covers packaged in accordance with the presently disclosed and/or claimed inventive concept(s).

FIG. 16C depicts another comparison of the space occupied by a certain number of preformed flower pot covers packaged in accordance with the presently disclosed and/or claimed inventive concept(s) and packaged by the prior art traditional carton method. As shown, 72,800 4″ SPEED COVER® preformed flower pot covers (Highland Supply Corp., Highland, Ill.) were packaged either in the apparatus of the presently disclosed and/or claimed inventive concept(s) (left) or in cartons as currently used in the art (right). As can be seen, the preformed flower pot covers packaged in cartons occupies about four times the amount of space as the preformed flower pot covers packaged in accordance with the presently disclosed and/or claimed inventive concept(s).

These Figures illustrate some of the advantages of the presently disclosed and/or claimed inventive concept(s). First, the amount of warehouse, packing area, and trailer space required for a package of a certain number of containers is greatly reduced when the containers are packaged according to the presently disclosed and/or claimed inventive concept(s) (as opposed to the prior art carton method). In addition, the requirement of the cartons is eliminated, and therefore disposal of the cardboard present in the cartons is no longer required; this provides an environmentally friendly feature to the presently disclosed and/or claimed inventive concept(s), as it reduces the amount of cardboard consumption as well as the costs associated with cardboard disposal. In addition to a reduction in space required by the packaged containers, labor and handling costs are also reduced. As more containers can be shipped in a single truckload, diesel consumption for transport of the containers is reduced along with the carbon footprint associated with transport. These features thus provide a manufacturer with an improved sustainability scorecard.

In addition, the packaged apparatus disclosed or otherwise contemplated herein allows for faster unloading of arriving trucks (as compared to containers packaged in cartons) and thereby reduces the amount of labor required. Also, since the packaged containers may be secured to a platform, pallet movers may be utilized for movement thereof, thus further reducing the amount of manual labor required as compared to the prior art packages. Yet further, the compact size of the packaged units formed using the apparatuses disclosed or otherwise contemplated herein results in the presence of more containers in a packing area, thus further reducing packing labor and time.

For example, three individuals are generally required to load or unload a 53 foot long trailer packed with floor loaded cartons, and the loading or unloading process takes approximately four hours. In contrast, a single individual can load or unload a 53 foot long trailer, and the loading or unloading process only takes approximately one hour. Therefore, significant savings in both labor and time (and subsequently a significant savings in the costs associated therewith) are observed with the presently disclosed and/or claimed inventive concept(s).

The packaging methods disclosed or otherwise contemplated herein also possess other advantages over the prior art carton method. As can be seen in FIG. 16, the containers packaged in accordance with the presently disclosed and/or claimed inventive concept(s) are visible, whereas containers cannot be viewed through the prior art cartons in which they may be packaged. This allows for quick identification of desired packaged containers (i.e., based on shape, size, color, etc.). In addition, different types of containers (that may vary by shape, size, and/or color, etc.) may be packaged together in a single apparatus, as described in greater detail herein above, and quicker identification and selection of a particular type of container from a plurality of different types of containers is aided by this packaging method.

### Example 2

As stated herein above, the packaging methods disclosed or otherwise contemplated herein provide a significant and substantial savings in freight as compared to containers that are shipped floor loaded in cartons. To illustrate this savings, Table 1 below provides a comparison of the size and cost associated with shipping a total of 1,156,500 SPEED COVER® preformed flower pot covers (Highland Supply Corp., Highland, Ill.) by the two methods described above. As can be seen, carton packed covers require twice as much space as the covers packed in accordance with the presently disclosed and/or claimed inventive concept(s), resulting in about twice as much freight cost.

TABLE 1

| | Use of | Use of Floor |
|---|---|---|
| | Apparatus | Loaded |
| | Disclosed Herein | Cartons |
| Number of Covers to Ship | 1,156,500 | 1,156,500 |
| Number of Apparatus/Cartons Required | 32 | 2,862 |
| Number of Truckload Feet Occupied | 53 linear feet | 106 linear feet |
| Truckload Cost | $2,145.79 | $4,183.89 |

| | |
|---|---|
| Freight Savings when Apparatus Used | $2,038.10 |

### FIG. 3

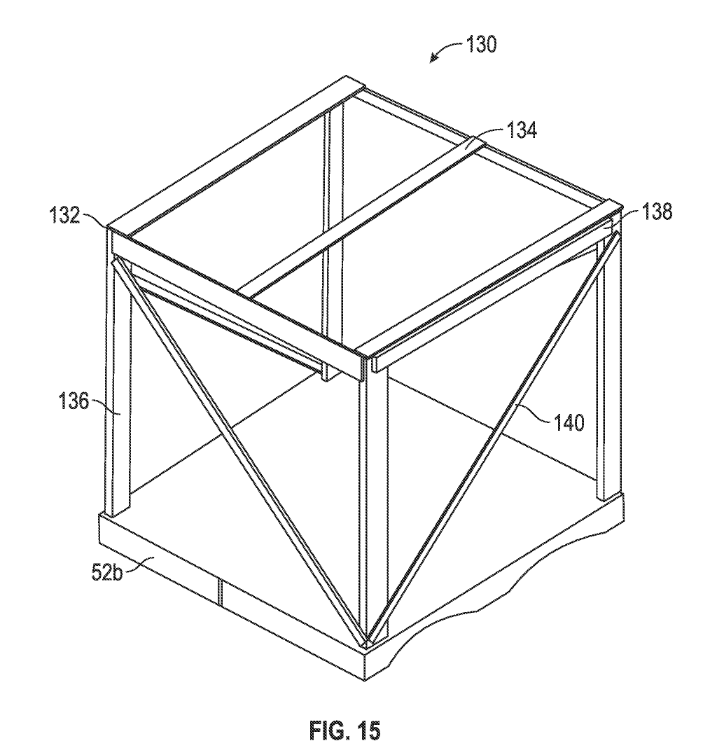

FIGS. 17 and 18 illustrate truck load plans for shipment of 923,100 SPEED COVER® preformed flower pot covers (Highland Supply Corp., Highland, Ill.) using either the apparatuses of the presently disclosed and/or claimed inventive concept(s) (FIG. 17) or the prior art floor loaded cartons (FIG. 18).

FIG. 17 is a truck load plan for shipment of the covers via the apparatuses disclosed or otherwise contemplated herein. The load plan is for a single 53 foot long trailer and includes 22 apparatuses that occupied 36.67 linear feet.

However, when this same number of covers is shipped in floor loaded cartons, two trailers are required. FIG. 18A contains a floor load plan for a first trailer that was filled to 51.94 linear feet, while FIG. 18B contains a floor load plan for a second trailer that was loaded to 17.46 linear feet. Thus, a total of 69.39 linear feet were occupied in the two trailers for shipping the floor loaded cartons of covers. Therefore, the floor loaded cartons required 32.72 additional feet or 89% more space in comparison to shipment of the same amount of covers using the apparatuses disclosed or otherwise contemplated herein.

Thus, in accordance with the presently disclosed and/or claimed inventive concept(s), there has been provided devices and apparatuses for packing, shipping, and/or storing containers, as well as methods of producing and using same, that fully satisfy the objectives and advantages set forth hereinabove. Although the presently disclosed and/or claimed inventive concept(s) has been described in conjunction with the specific drawings, results, and language set forth hereinabove, it is evident that many alternatives, modifications, and variations will be apparent to those skilled in the art. Accordingly, it is intended to embrace all such alternatives, modifications, and variations that fall within the spirit and broad scope of the presently disclosed and/or claimed inventive concept(s). Changes may be made in the construction and the operation of the various components, elements, and assemblies described herein, as well as in the steps or the sequence of steps of the methods described herein, without departing from the spirit and scope of the presently disclosed and/or claimed inventive concept(s) as defined in the following claims.

1. A method of packing, shipping, and/or storing a stack of floral containers, the method comprising the steps of:
moving at least one structural support member from a collapsed condition to an erect condition, the structural support member having a flattened condition and an erect condition and a top, a bottom, a sidewall, an outer peripheral surface, and an inner peripheral surface that defines a receiving space when the structural support member is in the erect condition, the structural support member being shaped to support at least a portion of a floral container;
disposing the at least one structural support member on a surface of a platform to form an apparatus; and
disposing at least one stack of floral containers on the apparatus so that the at least one structural support member stabilizes the at least one stack of floral containers and reduces shifting, leaning, and/or instability of the at least one stack of floral containers, and wherein at least one of:
(a) the outer peripheral surface of the structural support member contacts at least a portion of a peripheral surface of a terminal floral container in the stack of floral containers; and
(b) the receiving space of the structural support member receives at least a portion of a terminal floral container in the stack of floral containers.

2. The method of claim 1, wherein each of the floral containers is selected from the group consisting of a preformed flower pot cover, a container for a floral grouping, and a combination thereof.

3. The method of claim 1, wherein a plurality of structural support members are moved to an erect condition and disposed on the surface of the platform, and wherein the plurality of structural support members comprises at least two different sizes and/or shapes of structural support members.

4. The method of claim 3, wherein the step of disposing at least one stack of floral containers on the apparatus is further defined as disposing at least two stacks of floral containers on the apparatus so that the plurality of structural support members stabilizes the two or stacks of floral containers and reduces shifting, leaning, and/or instability of the at least two stacks of floral containers.

5. The method of claim 4, wherein the floral containers present in a first stack of floral containers have a different size and/or shape than the floral containers present in a second stack of floral containers.

6. The method of claim 4, wherein the at least two stacks of floral containers are supported in the same direction of orientation.

7. The method of claim 6, wherein the at least two stacks of floral containers are supported in an upright orientation.

8. The method of claim 6, wherein the at least two stacks of floral containers are supported in an inverted orientation.

9. The method of claim 4, wherein the at least two stacks of floral containers are supported in two different directions of orientation.

10. The method of claim 9, wherein at least one stack of floral containers is supported in an upright orientation, and at least one stack of floral containers is supported in an inverted orientation.

11. The method of claim 1, further comprising the step of wrapping a securing element about a periphery of the stack(s) of containers and at least a portion of the apparatus, wherein the securing element is selected from the group consisting of stretch film, shrink wrap, a strap, a tape, a band, a string, a twine, and combinations thereof.

12. The method of claim 1, wherein the stack(s) of floral containers are further defined as stack(s) of nested floral containers.

13. A method of packing, shipping, and/or storing a stack of floral containers, the method comprising the steps of:
forming a first packaged unit by the method of claim 1, wherein the apparatus of the first packaged unit comprises at least one stacking element having at least one platform receiving surface;
forming a second packaged unit by the method of claim 1; and
stacking the second packaged unit on top of the first packaged unit, whereby the platform of the second packaged unit contacts at least a portion of the at least one platform receiving surface of the apparatus of the first packaged unit.

14. A packaged unit, comprising:
an apparatus comprising at least one structural support member associated with at least one surface of a platform; and
at least two stacks of floral containers disposed on and supported by the apparatus, wherein at least one of the stacks of floral containers is supported in an upright orientation and at least one of the other stacks of floral containers is supported in an inverted orientation.

15. The packaged unit of claim 14, wherein the apparatus is further defined as comprising a plurality of structural support members.

16. The packaged unit of claim 15, wherein the plurality of structural support members comprises at least two different sizes and/or shapes of structural support members.

17. The packaged unit of claim 14, wherein the space of the apparatus occupied by the at least two stacks of floral containers is less than a space of the apparatus that would be occupied if the at least two stacks of floral containers were oriented in the same direction.

18. The packaged unit of claim 14, wherein the stack(s) of containers are further defined as stack(s) of nested containers.

19. The packaged unit of claim 14, wherein the apparatus further comprises at least one stabilizing element for stabilizing stack(s) of floral containers disposed upon the apparatus and reducing shifting, leaning, and/or instability of stack(s) of floral containers disposed on the apparatus.

20. The packaged unit of claim 14, wherein the apparatus further comprises at least one stacking element that comprises at least one platform receiving surface, whereby the apparatus is able to receive a second apparatus stacked on top thereof such that the platform of the second apparatus contacts at least a portion of the at least one platform receiving surface of the first apparatus.

21. A packaged unit, comprising:
a first packaged unit of claim 20; and
a second packaged unit of claim 14, wherein the second packaged unit is stacked on top of the first packaged unit, whereby the platform of the second packaged unit contacts at least a portion of the at least one platform receiving surface of the apparatus of the first packaged unit.

22-56. (canceled)
